(19) United States
(12) Patent Application Publication
(10) Pub. No.: US 2021/0307244 A1
(43) Pub. Date: Oct. 7, 2021

(54) Mower Utility Container Accessory

(71) Applicant: William Shaun McCleave, Grand Prairie, TX (US)

(72) Inventor: William Shaun McCleave, Grand Prairie, TX (US)

(21) Appl. No.: 17/173,988

(22) Filed: Feb. 11, 2021

Related U.S. Application Data
(60) Provisional application No. 62/975,345, filed on Feb. 12, 2020.

(51) Int. Cl. A01D 34/00; A01D 75/00

(52) U.S. Cl. CPC A01D 34/001; A01D 2101/00; A01D 75/008

(57) ABSTRACT

A mower utility container accessory designed to quickly and easily attach to a common walk behind lawnmower. The utility container may include a tub unit attached to a mounting frame with a hinged dumping capability. The utility container can be used to carry lawn and garden tools, and materials, or can be used to haul items around the yard or to the curb. When detached from the lawnmower the utility container can be stored standing on the front edge for small footprint area. The method of attachment to the lawnmower is at the folding handle wing nut or knob bolt that is common on many walk-behind lawnmowers or clamped to the handle upright arms. The front of the utility container accessory simply rests on the blade deck of the lawnmower. This allows the attachment and removal to be accomplished without tools.

### RELATED APPLICATIONS

This application claims the benefit of U.S. Provisional Application No. 62/975,345, filed Feb. 12, 2020, the contents of which are fully incorporated herein by reference.

### BACKGROUND OF THE INVENTIONS

### 1. Field of the Inventions

The present inventions generally pertain to containers to carry objects, and more particularly to such containers that can be attached to push lawn mowers.

### 2. Description of the Related Art

Various containers for use in transporting heavy, bulky or other objects around the lawn and garden are known. For example, wheelbarrows are known for moving objects from one location to another location, such as across a homeowner's yard. Push or walk-behind lawnmowers are also well known. Others have sought to develop new products for use in conjunction with push or other lawnmowers for moving objects (e.g., rocks, tree limbs, etc.), examples of which are shown in the follow patents: U.S. Pat. No. 5,417,353 to Stall entitled Mower Caddy; U.S. Pat. No. 7,448,691 to Brooks entitled Mower Payload Bin; U.S. Pat. No. 7,448,691 to Easom entitled Accessory Holder; and United States Patent Application Publication No. 2010/0083625 to Blair entitled Mower Mate.

However, as will become apparent from the description and explanation set forth below, there has remained a need in the art for an improved container for use in conjunction with a push mower. As explained and illustrated herein, the present inventions meet this need.

### SUMMARY OF THE INVENTIONS

The present inventions provide various embodiments of mower utility container accessories that provide the utility features of a wheelbarrow, but as an accessory to a standard lawnmower. When coupled with a self-propelled lawnmower the utility container accessories of the present inventions may be further enhanced by the powered drive. In this embodiment, a powered drive lawnmower makes the movement of heavier loads easy. The utility container accessories of the present inventions may provide a valued aid for normal lawnmower use to tote lawn equipment and tools or to pick up small limbs and trash from the lawn during regular cuttings. A unique feature is that the lawnmower can serve a much more expanded service all in one consolidated lawn and garden tool. Also, no additional storage space is needed in the garage or tool shed because the present inventions will use the same footprint as the lawnmower.

In one aspect, the present inventions may encompass a mower utility container accessory comprising a container bucket, and a support frame having a left generally horizontal support arm, a right generally horizontal support arm, a left front generally vertical support leg, a right front generally vertical support leg, and a front generally horizontal cross member, the left generally horizontal support arm and the right generally horizontal support arm being spaced apart in generally parallel relationship and connected together by the front generally horizontal cross member, the front generally horizontal cross member being disposed in generally perpendicular relationship to the left generally horizontal support arm and the right generally horizontal support arm, the left generally vertical support leg being connected adjacent a forward end of the left generally horizontal support arm in generally perpendicular relationship thereto, the right generally vertical support leg being connected adjacent a forward end of the right generally horizontal support arm in generally perpendicular relationship thereto, and a forward end of the container bucket being rotatably connected to the front generally horizontal cross member, the container bucket being rotatably moveable between a lower position and an upper position. Another feature of this aspect of the present inventions may be that the mower utility container accessory may further include a rear generally horizontal cross member connected between and disposed in generally perpendicular relationship to the left generally horizontal support arm and the right generally horizontal support arm. Another feature of this aspect of the present inventions may be that the left generally vertical support leg is connected to the front generally horizontal cross member in generally perpendicular relationship thereto, and the right generally vertical support leg is connected to the front generally horizontal cross member in generally perpendicular relationship thereto. Another feature of this aspect of the present inventions may be that the left generally vertical support leg includes a left outer sleeve and a left telescoping member slidably disposed within the left outer sleeve and releasably attachable thereto, and the right generally vertical support leg includes a right outer sleeve and a right telescoping member slidably disposed within the right outer sleeve and releasably attachable thereto. Another feature of this aspect of the present inventions may be that the left generally vertical support leg is rotatably connected to a forward end of the left generally horizontal support arm and releasably attachable thereto, and the right generally vertical support leg is rotatably connected to a forward end of the right generally horizontal support arm and releasably attachable thereto. Another feature of this aspect of the present inventions may be that the left generally horizontal support arm includes a left outer sleeve and a left rear telescoping member slidably disposed within the left outer sleeve and releasably attachable thereto, and the right generally horizontal support arm includes a right outer sleeve and a right rear telescoping member slidably disposed within the right outer sleeve and releasably attachable thereto. Another feature of this aspect of the present inventions may be that a rearward end of the left generally horizontal support arm is attached to a left handle of a push lawnmower, a rearward end of the right generally horizontal support arm is attached to a right handle of the push lawnmower, the left generally vertical support leg is resting on top of a mower deck of the lawnmower, and the right generally vertical support leg is resting on top of the mower deck.

In another aspect, the present inventions may encompass a mower utility container accessory comprising: a container bucket, a generally rectangular support member, and a support frame having a left generally horizontal support arm, a right generally horizontal support arm, a left front generally vertical support leg, a right front generally vertical support leg, and a front generally horizontal cross member, the left generally horizontal support arm and the right generally horizontal support arm being spaced apart in generally parallel relationship and connected together by the front generally horizontal cross member, the front generally horizontal cross member being disposed in generally perpendicular relationship to the left generally horizontal support arm and the right generally horizontal support arm, the left generally vertical support leg being connected adjacent a forward end of the left generally horizontal support arm in generally perpendicular relationship thereto, the right generally vertical support leg being connected adjacent a forward end of the right generally horizontal support arm in generally perpendicular relationship thereto, the container bucket being attached to the generally rectangular support member, and a forward end of the generally rectangular support member being rotatably connected to the front generally horizontal cross member, the container bucket being rotatably moveable between a lower position and an upper position. Another feature of this aspect of the present inventions may be that the mower utility container accessory may further include a rear generally horizontal cross member connected between and disposed in generally perpendicular relationship to the left generally horizontal support arm and the right generally horizontal support arm. Another feature of this aspect of the present inventions may be that the left generally vertical support leg is connected to the front generally horizontal cross member in generally perpendicular relationship thereto, and the right generally vertical support leg is connected to the front generally horizontal cross member in generally perpendicular relationship thereto. Another feature of this aspect of the present inventions may be that the left generally vertical support leg includes a left outer sleeve and a left telescoping member slidably disposed within the left outer sleeve and releasably attachable thereto, and the right generally vertical support leg includes a right outer sleeve and a right telescoping member slidably disposed within the right outer sleeve and releasably attachable thereto. Another feature of this aspect of the present inventions may be that the left generally vertical support leg is rotatably connected to a forward end of the left generally horizontal support arm and releasably attachable thereto, and the right generally vertical support leg is rotatably connected to a forward end of the right generally horizontal support arm and releasably attachable thereto. Another feature of this aspect of the present inventions may be that the left generally horizontal support arm includes a left outer sleeve and a left rear telescoping member slidably disposed within the left outer sleeve and releasably attachable thereto, and the right generally horizontal support arm includes a right outer sleeve and a right rear telescoping member slidably disposed within the right outer sleeve and releasably attachable thereto. Another feature of this aspect of the present inventions may be that a rearward end of the left generally horizontal support arm is attached to a left handle of a push lawnmower, a rearward end of the right generally horizontal support arm is attached to a right handle of the push lawnmower, the left generally vertical support leg is resting on top of a mower deck of the lawnmower, and the right generally vertical support leg is resting on top of the mower deck.

In another aspect, the present inventions may encompass a method of improving a push lawnmower having a left handle, a right handle, and a mower deck, the left and right handles extending upwardly away from the mower deck at an inclined angle, the method comprising: providing a mower utility container accessory comprising a container bucket, and a support frame having a left generally horizontal support arm, a right generally horizontal support arm, a left front generally vertical support leg, a right front generally vertical support leg, and a front generally horizontal cross member, the left generally horizontal support arm and the right generally horizontal support arm being spaced apart in generally parallel relationship and connected together by the front generally horizontal cross member, the front generally horizontal cross member being disposed in generally perpendicular relationship to the left generally horizontal support arm and the right generally horizontal support arm, the left generally vertical support leg being connected adjacent a forward end of the left generally horizontal support arm in generally perpendicular relationship thereto, the right generally vertical support leg being connected adjacent a forward end of the right generally horizontal support arm in generally perpendicular relationship thereto, and a forward end of the container bucket being rotatably connected to the front generally horizontal cross member, the container bucket being rotatably moveable between a lower position and an upper position; attaching a rearward end of the left generally horizontal support arm to the left handle of the lawnmower; attaching a rearward end of the right generally horizontal support arm to the right handle of the lawnmower; positioning the left generally vertical support leg on the mower deck; and positioning the right generally vertical support leg on the mower deck. Another feature of this aspect of the present inventions may be that the mower utility container accessory further includes a rear generally horizontal cross member connected between and disposed in generally perpendicular relationship to the left generally horizontal support arm and the right generally horizontal support arm. Another feature of this aspect of the present inventions may be that the left generally vertical support leg is connected to the front generally horizontal cross member in generally perpendicular relationship thereto, and the right generally vertical support leg is connected to the front generally horizontal cross member in generally perpendicular relationship thereto. Another feature of this aspect of the present inventions may be that the left generally vertical support leg includes a left outer sleeve and a left telescoping member slidably disposed within the left outer sleeve and releasably attachable thereto, and the right generally vertical support leg includes a right outer sleeve and a right telescoping member slidably disposed within the right outer sleeve and releasably attachable thereto. Another feature of this aspect of the present inventions may be that the left generally vertical support leg is rotatably connected to a forward end of the left generally horizontal support arm and releasably attachable thereto, and the right generally vertical support leg is rotatably connected to a forward end of the right generally horizontal support arm and releasably attachable thereto. Another feature of this aspect of the present inventions may be that the left generally horizontal support arm includes a left outer sleeve and a left rear telescoping member slidably disposed within the left outer sleeve and releasably attachable thereto, and the right generally horizontal support arm includes a right outer sleeve and a right rear telescoping member slidably disposed within the right outer sleeve and releasably attachable thereto.

Other features, aspects and advantages of the present inventions will become apparent from the following discussion and detailed description.

### BRIEF DESCRIPTION OF THE DRAWINGS

FIG. 1 is a perspective view of a push lawnmower having a specific embodiment of a mower utility container accessory mounted thereto.

FIG. 2 is a top view of a specific embodiment of a container bucket for use as part of a specific embodiment of a mower utility container accessory.

FIG. 3 is a side view of a specific embodiment of a mower utility container accessory.

FIG. 4 is a bottom view of the mower utility container accessory shown in FIG. 3.

FIG. 5 is an end view of the left side of the mower utility container accessory as shown in FIGS. 3 and 4.

FIG. 6 is a perspective view of another specific embodiment of a mower utility container accessory mounted to lawnmower, with a container bucket in a lower position.

FIG. 7 is another perspective view of the mower utility container accessory and lawnmower as shown in FIG. 6, but from an opposite side of the lawnmower.

FIG. 8 is another perspective view of the mower utility container accessory and lawnmower as shown in FIGS. 6 and 7, but from the rear left of the lawnmower and with the container bucket in an upper or dumping position.

FIG. 9 is another perspective view similar to FIG. 8 but from the rear right of the lawnmower and mower utility container accessory.

FIG. 10 is another perspective view similar to FIGS. 8 and 9, with the container bucket in its upper or dumping position, but from the front of the lawnmower and mower utility container accessory.

FIG. 11 is a front perspective view of a specific embodiment of a mower utility container accessory constructed in accordance with the present inventions (not mounted to a lawnmower), and illustrating how the telescoping front legs can be adjusted to allow the accessory to be mounted to a variety of makes and models of push lawnmowers.

FIG. 12 is another front perspective view similar to FIG. 11, but showing the front legs after they have been rotated inwardly.

FIG. 13 is a perspective view of a telescoping front leg constructed in accordance with the present inventions.

FIG. 14 is a perspective view looking upwardly toward the underneath side of the container bucket and further illustrating the rotatable connection of the front vertical legs.

FIG. 15 is another view similar to FIG. 14 from a different angle.

FIG. 16 is a perspective view of a telescoping section at a rearward end of a right generally horizontal support arm to facilitate adjustability of the utility container accessory to be mounted to a variety of makes and models of push lawnmowers.

FIG. 17 is a perspective view illustrating a specific embodiment of a bracket that may be used to connect horizontal support arms of the mower utility container accessory to left and right handles of a lawnmower.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

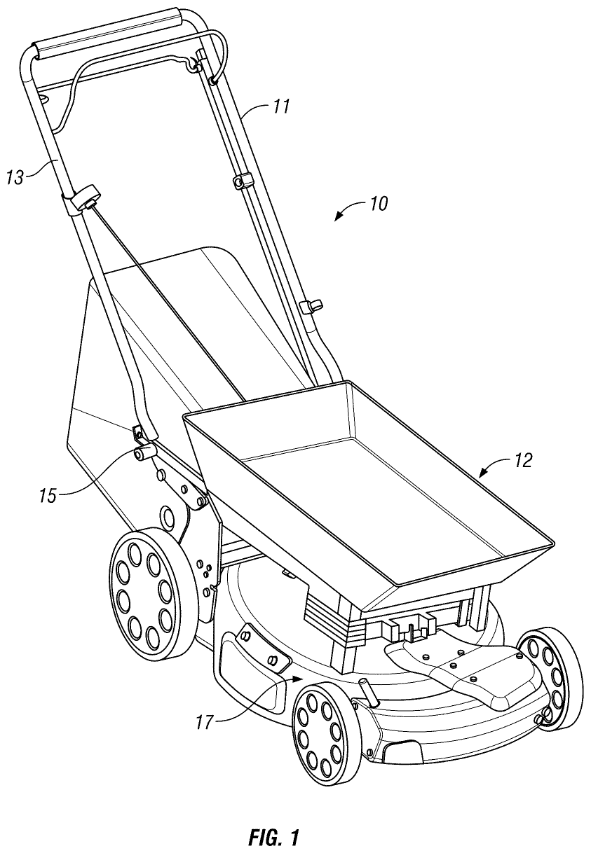

Referring to the drawings in detail, wherein like numerals denote identical elements throughout the several views, and referring initially to FIG. 1, there is shown a perspective view of a conventional gas or electric lawnmower 10 having a specific embodiment of a mower utility container accessory 12 mounted thereon. The lawnmower 10 includes a left handle 11 and a right handle 13 extending rearwardly from a mower deck 17. In a specific embodiment, the lower ends of the left and right handles 11 and 13 may be adapted to fold upon disengagement of connectors such as knobs or wingnuts, such as at folding joint 15 at the lower end of the right handle 13.

### First Embodiment

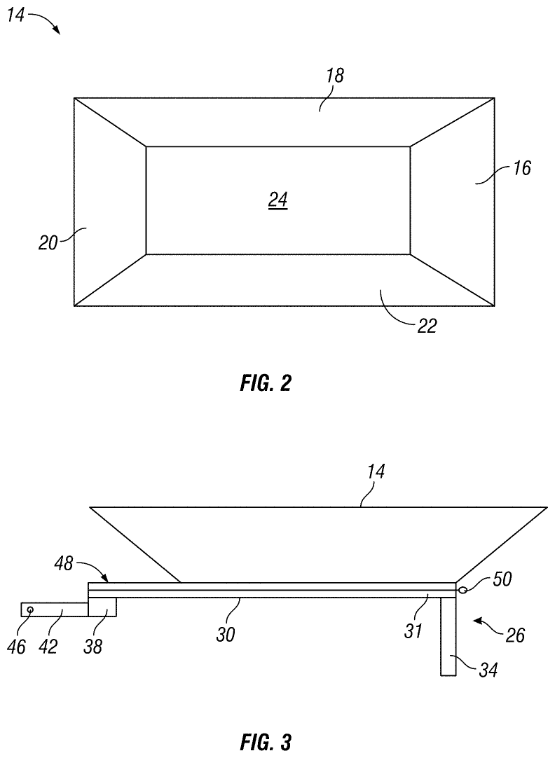

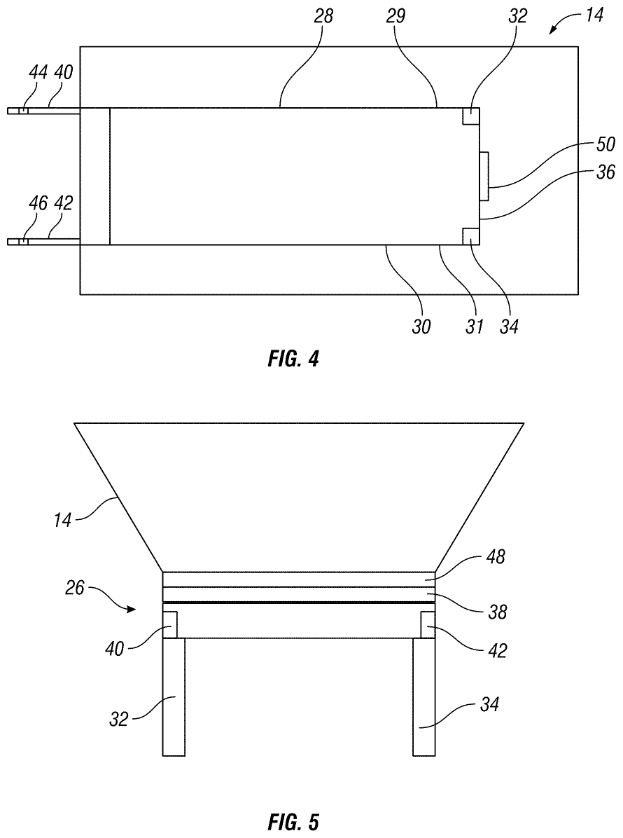

A specific embodiment of the mower utility container accessory 12 will now be described in more detail in connection with FIGS. 2-5. With reference to FIG. 2, a container bucket or pan 14 is shown, which can be used much like a conventional wheelbarrow. The container bucket 14 may be made from a variety of materials, such as plastic, wood, metal or composites, for example. In a specific embodiment, the container bucket 14 may include sloped side walls 16, 18, 20, and 22 extending up from a floor 24 of the bucket 14 for easy access or dumping. In a specific embodiment, the container 14 may be of sufficient size to carry standard lawn and garden tools and materials, such as mulch, soil, fertilizer, plants, and lawn tools.

As shown in FIGS. 3-5, a specific embodiment of the mower utility container accessory 12 may include a support frame 26 having a left generally horizontal support arm 28, a right generally horizontal support arm 30, a left front generally vertical support leg 32, a right front generally vertical support leg 34, a front generally horizontal cross member 36, and a rear generally horizontal cross member 38. In a specific embodiment, the left generally horizontal support arm 28 and the right generally horizontal support arm 30 may be spaced apart in generally parallel relationship and connected together by the front and rear generally horizontal cross members 36 and 38. In a specific embodiment, the front and rear generally horizontal cross members 36 and 38 may be disposed in generally perpendicular relationship to the left generally horizontal support arm 28 and the right generally horizontal support arm 30.

In a specific embodiment, the left generally vertical support leg 32 may be connected to a forward end 29 of the left generally horizontal support arm 28 in generally perpendicular relationship thereto, and to the front generally horizontal cross member 36 in generally perpendicular relationship thereto. In a specific embodiment, the right generally vertical support leg 34 may be connected to a forward end 31 of the right generally horizontal support arm 30 in generally perpendicular relationship thereto, and to the front generally horizontal cross member 36 in generally perpendicular relationship thereto. The support legs 32 and 34 are adapted to rest on the mower deck 17 of the lawnmower 10 as shown in FIG. 1, and to transfer the loads from the container bucket 14 to the lawnmower 10. In a specific embodiment, the support legs 32 and 34 may be configured to accommodate the contour of the upper surface of the mower deck 17. The support legs 32 and 34 may also be of fixed length and lateral position, or may be adjustable as needed for a more universal adaptation to the mower deck 17.

The support frame 26 may also include a left generally horizontal rear extension arm 40 and a right generally horizontal rear extension arm 42. In a specific embodiment, the left and right generally horizontal rear extension arms 40 and 42 may be connected in generally perpendicular relationship to the rear generally horizontal cross member 38. In a specific embodiment, the left and right generally horizontal rear extension arms 40 and 42 may be integrally formed as part of the left and right generally horizontal support arms 28 and 30, respectively. In a specific embodiment, the left generally horizontal rear extension arm 40 may include an aperture 44 adapted to receive a connector to secure the left generally horizontal rear extension arm 40 to a left handle 11 of the lawnmower 10 as shown in FIG. 1. In a specific embodiment, the right generally horizontal rear extension arm 42 may include an aperture 46 adapted to receive a connector to secure the right generally horizontal rear extension arm 42 to a right handle 13 of the lawnmower 10 as shown in FIG. 1. In a specific embodiment, existing knobs or wing nuts at a folding joint of the left or right handle of the lawnmower 10, such as the folding joint 15 on the right handle 13 shown in FIG. 1, may be used to engage with the apertures 44 and 46 on the rear extension arms 40 and 42 (or support arms 28 and 30), respectively. The rear extension arms 40 and 42 may also be secured to the handles 11 and 13, respectively, by the use of clamps. Attachment of the mower utility container accessory 12 to the handles 11 and 13 supports the rear of the mower utility container accessory 12 and allows the floor 24 of the container bucket 14 to rest relatively level with the mower deck 17.

In a specific embodiment, the rear extension arms 40 and 42 may be designed to uniquely fit a specific lawnmower application or be of universal design to adjust to various handle configurations of a conventional lawnmower. The rear extension arms 40 and 42 may attach to the lawnmower handles 11 and 13 in various methods, such as through the use of a mounting hole, such as apertures 44 and 46, to accept the handle pivot bolt, or through the use of a clamping feature to clamp the support structure to the lawnmower handles. The primary attachment of the mower utility container accessory 12 to the lawnmower 10 will be at the interface between the rear extension arms 40 and 42 and the lawnmower handles 11 and 13. The various embodiments of the mower utility container accessory 12 are designed to be easily attached and removed from the lawnmower 10, but may stay attached to the lawnmower 10 for ready convenience in normal lawn maintenance.

In a specific embodiment, the mower utility container accessory 12 may also include a generally rectangular support member or flip board 48 that may generally conform to the width and length of the support frame 26. In a specific embodiment, the generally rectangular support member 48 may be connected by a hinge 50 to the front generally horizontal cross member 36. In a specific embodiment, the hinge 50 may be a conventional hinge unit much like a standard door hinge or can be of other flexible materials allowing the pivotal hinge motion for dumping of the container bucket 14. In a specific embodiment, the container bucket 14 may be connected to the generally rectangular support member 48. As such, the container bucket 14 can be lifted from the rear and rotated around the hinge 50 when it is desired to dump or unload the contents of the container bucket 14. Lifting is done by the operator, who will grab the rear section of the container bucket 14 and pull upward, allowing the bucket 14 to pivot about the hinge 50. In a specific embodiment, the container bucket 14 may also be hingedly connected directly to the front generally horizontal cross member 36 without including the generally rectangular support member or flip board 48.

In a specific embodiment, the mower utility container accessory 12 and its various components may be constructed from wood, plastic, metal, composite, or a combination of any of these materials. In a specific embodiment, the mower utility container accessory 12 may be specifically designed and dimensioned to fit a particular brand and model of lawnmower, or it may be provided in an adjustable universal configuration such that it can be adjusted to fit a broad spectrum of lawnmower brands and models. In a specific embodiment, the forward legs 32 and 34 may also have adjustment features for custom fitting to the lawnmower 10. In a specific embodiment, the rear attachment of the mower utility container accessory 12 may also contain adjustments to adapt to the lawnmower 10 for a custom fit.

### Second Embodiment

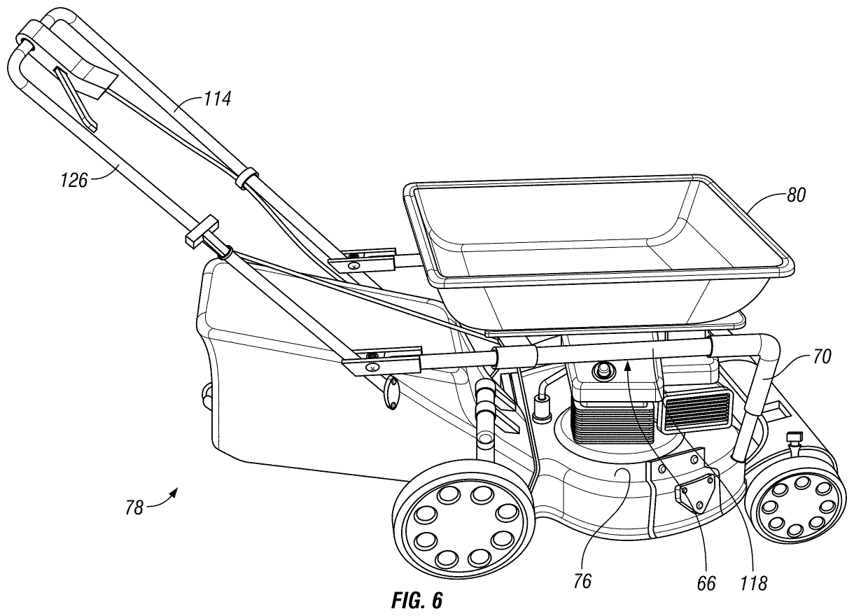

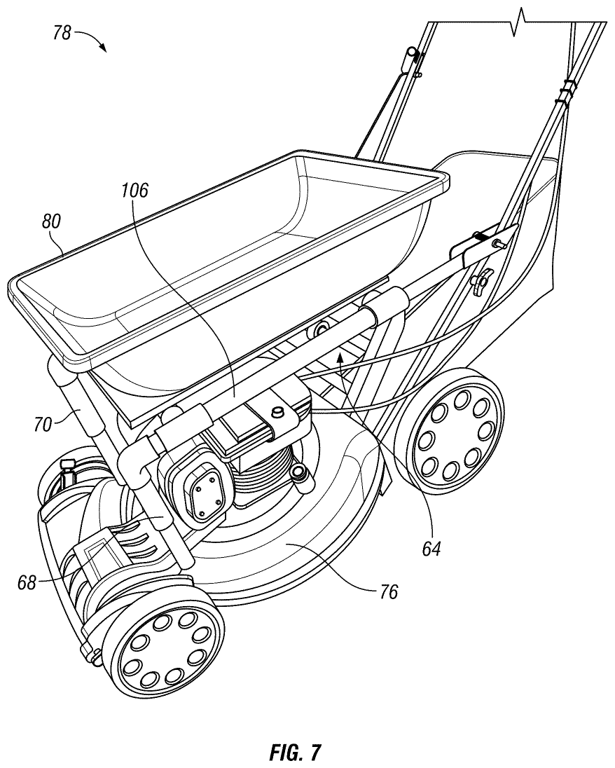

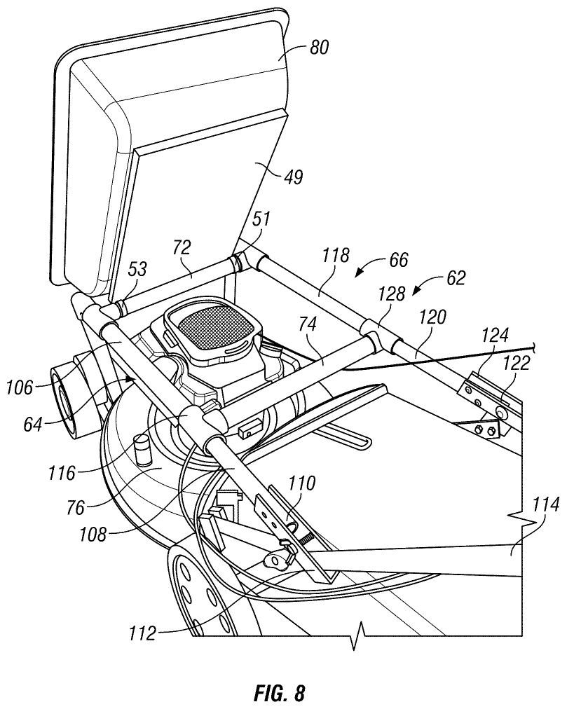

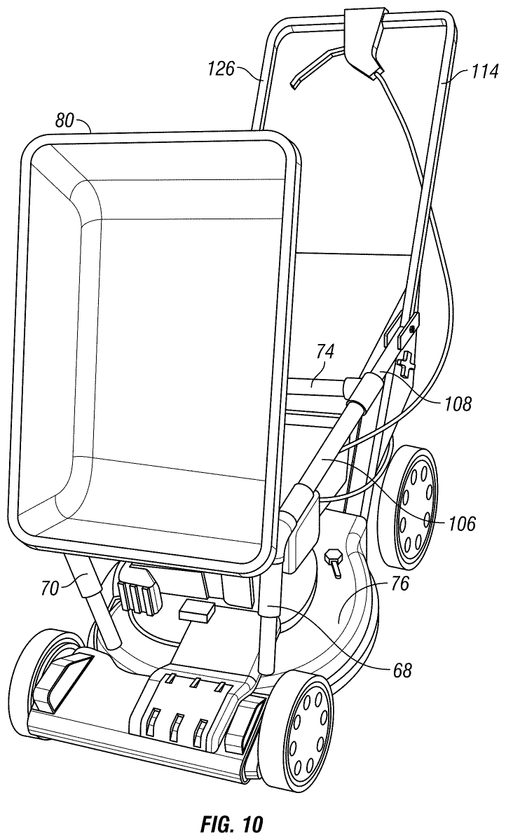

In another specific embodiment, a mower utility container accessory 60 having various adjustable features is illustrated in FIGS. 6-10. In this specific embodiment, the mower utility container accessory 60 may include a support frame 62 having a left generally horizontal support arm 64, a right generally horizontal support arm 66, a left front generally vertical support leg 68, a right front generally vertical support leg 70, a front generally horizontal cross member 72, and a rear generally horizontal cross member 74. In a specific embodiment, the left generally horizontal support arm 64 and the right generally horizontal support arm 66 may be spaced apart in generally parallel relationship and connected together by the front and rear generally horizontal cross members 72 and 74. In a specific embodiment, the front and rear generally horizontal cross members 72 and 74 may be disposed in generally perpendicular relationship to the left generally horizontal support arm 64 and the right generally horizontal support arm 66.

In a specific embodiment, the left generally vertical support leg 68 may be connected to a forward end of the left generally horizontal support arm 64 in generally perpendicular relationship thereto. In a specific embodiment, the right generally vertical support leg 70 may be connected to a forward end of the right generally horizontal support arm 66 in generally perpendicular relationship thereto. The support legs 68 and 70 are adapted to rest on the mower deck 76 of the lawnmower 78, and to transfer the loads from the container bucket 80 to the lawnmower 78. In a specific embodiment, the support legs 68 and 70 may be configured to accommodate the contour of the upper surface of the mower deck 76. The support legs 68 and 70 may also be of fixed length and lateral position, or may be adjustable as needed for a more universal adaptation to the mower deck 76, as further explained below.

In a specific embodiment, the mower utility container accessory 60 may also include a generally rectangular support member or flip board 49 that may generally conform to the width and length of the support frame 62. In a specific embodiment, the generally rectangular support member 49 may be hingedly connected, such as by a pair of generally C-shaped clamps 51 and 53, to the front generally horizontal cross member 72. In a specific embodiment, the hinged connection provided by the clamps 51 and 53 allow for a pivotal hinge motion for dumping of the container bucket 80. In a specific embodiment, the container bucket 80 may be connected to the generally rectangular support member 49. As such, the container bucket 80 can be lifted from the rear and rotated around the front generally horizontal cross member 72 when it is desired to dump or unload the contents of the container bucket 80. In a specific embodiment, the container bucket 80 may also be hingedly connected directly to the front generally horizontal cross member 72 without including the generally rectangular support member or flip board 49.

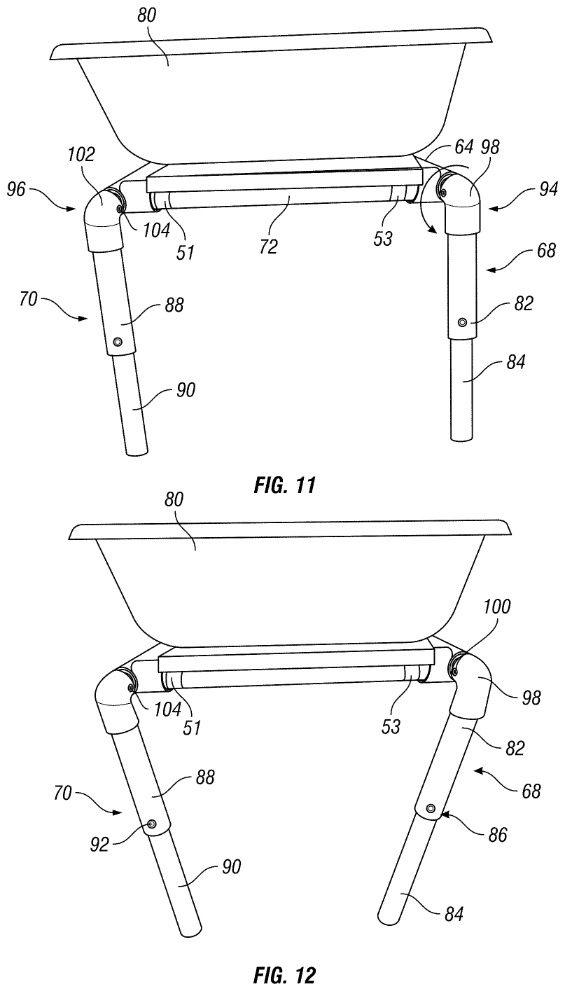

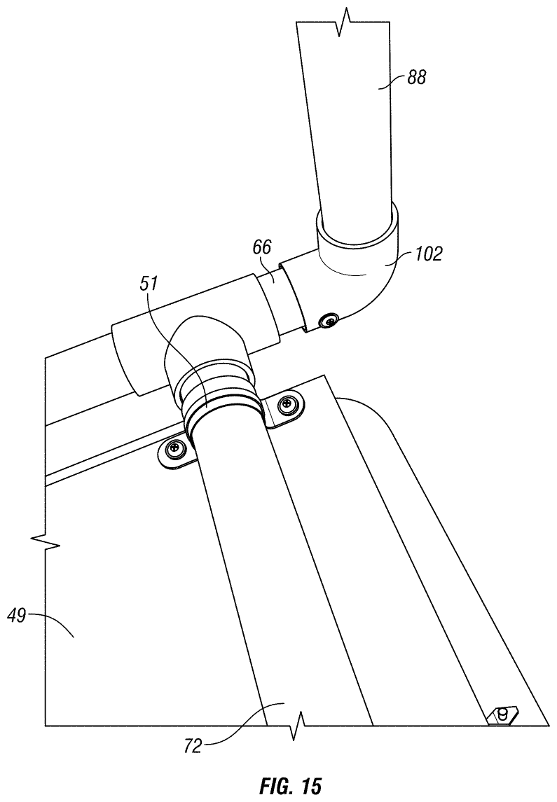

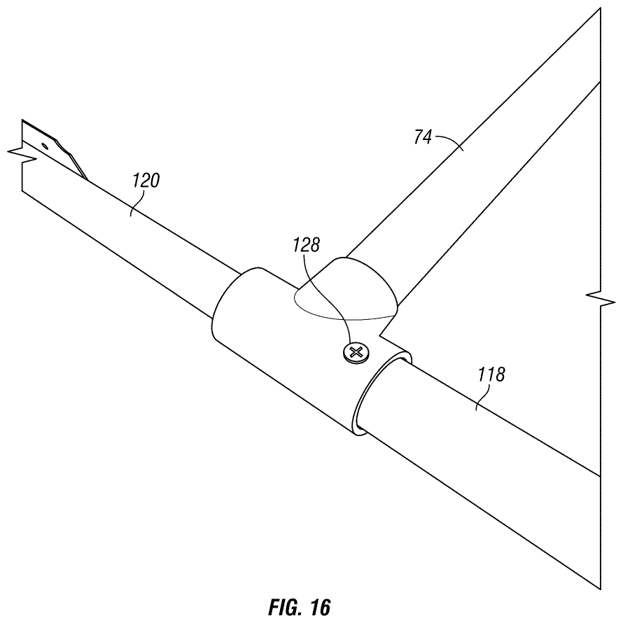

Details of how the support legs 68 and 70 may be adjustable in a specific embodiment will now be described. In this specific embodiment, by providing adjustable support legs 68 and 70, the mower utility container accessory 60 may be optimized to be universally adaptable to different brands and makes of walk behind lawn mowers. One way this may be accomplished is by providing telescoping legs 68 and 70, as illustrated in FIGS. 11-15. With reference to FIGS. 11 and 12, the support leg 68 may include an outer sleeve 82 and a telescoping member 84 adapted for slidable movement up and down within the outer sleeve 82. An adjustment device 86 (e.g., a screw, etc.) is provided to secure the telescoping member 84 to the outer sleeve 82 at the desired height, and to allow for disengagement of the telescoping member 84 from the outer sleeve 82 in order to allow for movement of the telescoping member 84 within the outer sleeve 82 so the leg 68 can be adjusted to its desired height. Similarly, on the opposite side of the accessory 60, the support leg 70 may include an outer sleeve 88 with a telescoping member 90 releasably engageable and slidably moveable therein, and an adjustment device 92 to allow for releasable engagement of the telescoping member 90 to the outer sleeve 88.

In a specific embodiment, the front vertical legs 68 and 70 may also be provided with the ability for lateral movement, so that the distance between the lower ends of the legs 68 and 70 can be adjusted to allow the accessory 60 to be universally adjusted to fit various makes and models of lawnmowers. In a specific embodiment, this functionality can be achieved by making upper ends 94 and 96 of the legs 68 and 70, respectively, releasably rotatable relative to the forward ends of the left and right generally horizontal support arms 64 and 66, respectively.

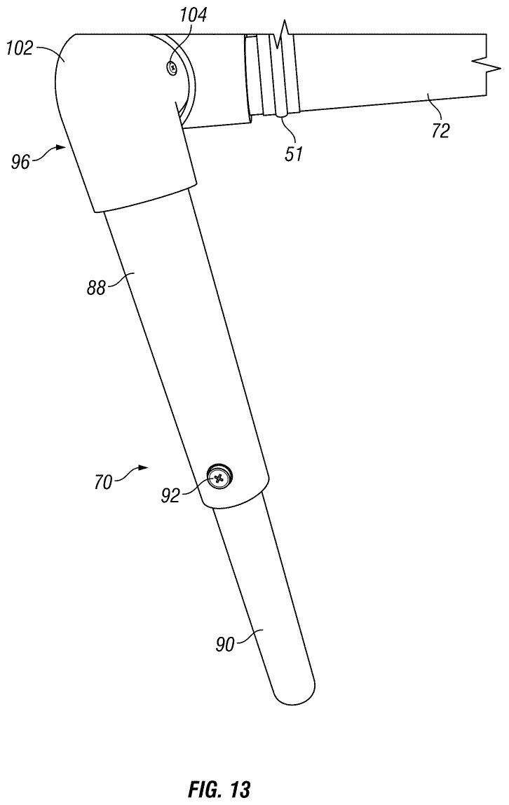

In a specific embodiment, as shown in FIGS. 11 and 12, the upper end 94 of the support leg 68 may be provided with an elbow 98 having a generally horizontal extension having an internal bore adapted for receiving the front end of the support arm 64, which in this specific embodiment may be a round rod. A securing device 100 (e.g., a screw, etc.) may be provided to releasably secure the elbow 98 and attached support leg 68 in its desired position. By releasing the securing device 100, the elbow 98 can be rotated relative to the front end of the support arm 64 until the lower end of the support leg 68 is in its desired position, depending on the size and shape of the lawnmower to which the accessory 60 is being mounted; and once the support leg 68 is in its desired position, the elbow 98 and support leg 68 can be fastened in place with the securing device 100. Similarly, on the other side of the accessory 60, as best shown in FIG. 13, the upper end 96 of the support leg 70 may be provided with an elbow 102 for rotatable engagement with the front end of the support arm 66, and a securing device 104 to allow for releasable engagement of the elbow 102 to the front end of the support arm 66.

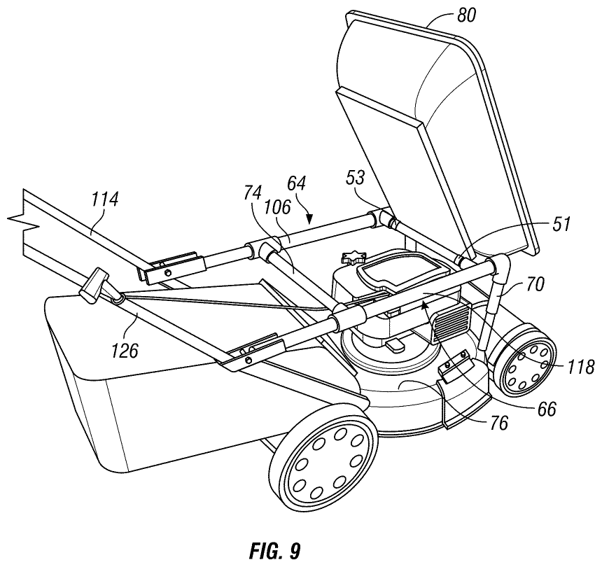

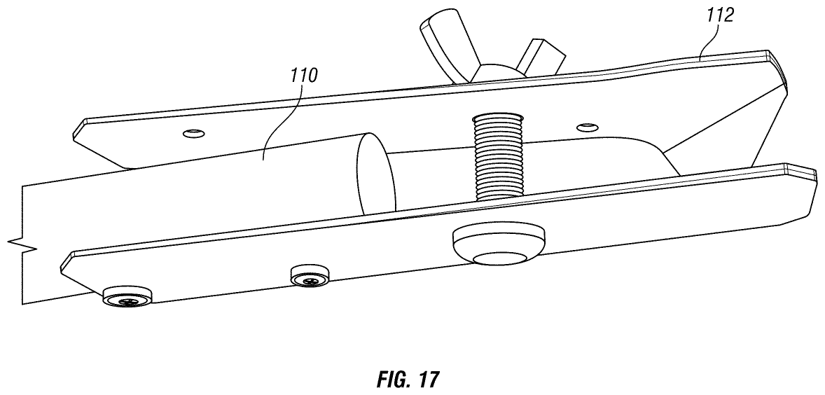

Further adjustability of the accessory 60 may be provided at its rearward end by providing the ability of the rearward ends of the left and right support arms 64 and 66 to telescope in a manner similar to the telescoping front vertical legs 68 and 70. In a specific embodiment, as shown for example in FIGS. 8 and 9, the left support arm 64 may be provided with a left outer sleeve 106 and a left rear telescoping member 108 adapted for slidable movement within the left outer sleeve 106. In a specific embodiment, a distal end 110 of the left rear telescoping member 108 may include a left bracket 112 (see FIG. 17) adapted for attachment to a left handle 114 of the lawnmower 78. A left fastening device 116 may be provided to releasably secure the left rear telescoping member 108 to the left outer sleeve 106 when it has been moved into its desired position to fit the specific shape and size of the lawnmower 78 to which the accessory 60 is being attached.

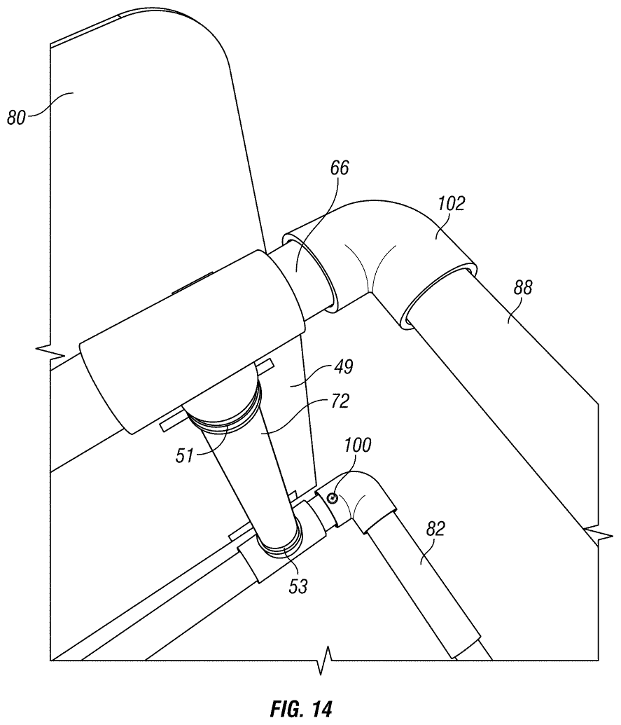

Similarly, in a specific embodiment, on the other side of the accessory 60, the right support arm 66 may be provided with a right outer sleeve 118 and a right rear telescoping member 120 adapted for slidable movement within the right outer sleeve 118. In a specific embodiment, a distal end 122 of the right rear telescoping member 120 may include a right bracket 124 adapted for attachment to a right handle 126 of the lawnmower 78. A right fastening device 128 (best shown in FIG. 14) may be provided to releasably secure the right rear telescoping member 120 to the right outer sleeve 118 when it has been moved into its desired position to fit the specific shape and size of the lawnmower 78 to which the accessory 60 is being attached.

It can now be seen that the accessory 60 may be provided with various adjustable features to enable to the accessory to universally fit a broad variety of makes and models of push lawnmowers. In a specific embodiment, this may be done in part by providing telescoping legs and rotating or swinging legs at the front. Because mower decks are different on different makes and models of lawnmowers and may have uneven surfaces, the accessory 60 may be designed to telescope forward and backward by sliding horizontal extensions in and out of left and right support arm tubes. Also, the accessory 60 may be able to move up and down by telescoping the front legs up and down to the ideal height. Further, the front legs may be provided with the ability to rotate or swing to position the support leg feet on the deck of the lawnmower at an ideal location.

In view of the above and foregoing description, it can be seen that the various embodiments of the mower utility container accessory 12/60, when attached to a standard lawnmower, provides the utility of a standard wheelbarrow and the convenience of an all in one assembly. The utility container accessory 12/60 quickly and easily attaches to a standard walk behind lawnmower, generally without the use of tools. The attachment is at the folding handle joint of the lawnmower 10 where typically a wingnut or knob is used, or it may be clamped directly to the handles 11 and 13. The front end of the utility container accessory 12/60 will simply rest its forward feet or legs 32 and 34 on top of the cutting deck 17 of the lawnmower 10. When coupled to a self-powered lawnmower the present inventions include the added feature of a powered drive hauler for the lawn and garden. The function of mowing the lawn is not encumbered by the utility container accessory 12/60. There is generally space allowed for airflow to the lawnmower, and no interference with the pull start feature. If access to check oil or add gas is blocked the utility container accessory 12/60 simply pivots up for access or is simply removed by unscrewing the wingnuts/knob or unclamping the clamps that attach it to the lawnmower 10. The utility container accessory 12/60 can be used to carry tools and loads like plants or fertilizer around the lawn and garden.

It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims.

1. A mower utility container accessory comprising:
a container bucket, and
a support frame having a left generally horizontal support arm, a right generally horizontal support arm, a left front generally vertical support leg, a right front generally vertical support leg, and a front generally horizontal cross member,
the left generally horizontal support arm and the right generally horizontal support arm being spaced apart in generally parallel relationship and connected together by the front generally horizontal cross member,
the front generally horizontal cross member being disposed in generally perpendicular relationship to the left generally horizontal support arm and the right generally horizontal support arm,
the left generally vertical support leg being connected adjacent a forward end of the left generally horizontal support arm in generally perpendicular relationship thereto,
the right generally vertical support leg being connected adjacent a forward end of the right generally horizontal support arm in generally perpendicular relationship thereto, and
a forward end of the container bucket being rotatably connected to the front generally horizontal cross member, the container bucket being rotatably moveable between a lower position and an upper position.

2. The mower utility container accessory of claim 1, further including a rear generally horizontal cross member connected between and disposed in generally perpendicular relationship to the left generally horizontal support arm and the right generally horizontal support arm.

3. The mower utility container accessory of claim 1, wherein the left generally vertical support leg is connected to the front generally horizontal cross member in generally perpendicular relationship thereto, and the right generally vertical support leg is connected to the front generally horizontal cross member in generally perpendicular relationship thereto.

4. The mower utility container accessory of claim 1, wherein the left generally vertical support leg includes a left outer sleeve and a left telescoping member slidably disposed within the left outer sleeve and releasably attachable thereto, and the right generally vertical support leg includes a right outer sleeve and a right telescoping member slidably disposed within the right outer sleeve and releasably attachable thereto.

5. The mower utility container accessory of claim 1, wherein the left generally vertical support leg is rotatably connected to a forward end of the left generally horizontal support arm and releasably attachable thereto, and the right generally vertical support leg is rotatably connected to a forward end of the right generally horizontal support arm and releasably attachable thereto.

6. The mower utility container accessory of claim 1, wherein the left generally horizontal support arm includes a left outer sleeve and a left rear telescoping member slidably disposed within the left outer sleeve and releasably attachable thereto, and the right generally horizontal support arm includes a right outer sleeve and a right rear telescoping member slidably disposed within the right outer sleeve and releasably attachable thereto.

7. The mower utility container accessory of claim 1, wherein a rearward end of the left generally horizontal support arm is attached to a left handle of a push lawnmower, a rearward end of the right generally horizontal support arm is attached to a right handle of the push lawnmower, the left generally vertical support leg is resting on top of a mower deck of the lawnmower, and the right generally vertical support leg is resting on top of the mower deck.

8. A mower utility container accessory comprising:
a container bucket,
a generally rectangular support member, and
a support frame having a left generally horizontal support arm, a right generally horizontal support arm, a left front generally vertical support leg, a right front generally vertical support leg, and a front generally horizontal cross member,
the left generally horizontal support arm and the right generally horizontal support arm being spaced apart in generally parallel relationship and connected together by the front generally horizontal cross member,
the front generally horizontal cross member being disposed in generally perpendicular relationship to the left generally horizontal support arm and the right generally horizontal support arm,
the left generally vertical support leg being connected adjacent a forward end of the left generally horizontal support arm in generally perpendicular relationship thereto,
the right generally vertical support leg being connected adjacent a forward end of the right generally horizontal support arm in generally perpendicular relationship thereto,
the container bucket being attached to the generally rectangular support member, and
a forward end of the generally rectangular support member being rotatably connected to the front generally horizontal cross member, the container bucket being rotatably moveable between a lower position and an upper position.

9. The mower utility container accessory of claim 8, further including a rear generally horizontal cross member connected between and disposed in generally perpendicular relationship to the left generally horizontal support arm and the right generally horizontal support arm.

10. The mower utility container accessory of claim 8, wherein the left generally vertical support leg is connected to the front generally horizontal cross member in generally perpendicular relationship thereto, and the right generally vertical support leg is connected to the front generally horizontal cross member in generally perpendicular relationship thereto.

11. The mower utility container accessory of claim 8, wherein the left generally vertical support leg includes a left outer sleeve and a left telescoping member slidably disposed within the left outer sleeve and releasably attachable thereto, and the right generally vertical support leg includes a right outer sleeve and a right telescoping member slidably disposed within the right outer sleeve and releasably attachable thereto.

12. The mower utility container accessory of claim 8, wherein the left generally vertical support leg is rotatably connected to a forward end of the left generally horizontal support arm and releasably attachable thereto, and the right generally vertical support leg is rotatably connected to a forward end of the right generally horizontal support arm and releasably attachable thereto.

13. The mower utility container accessory of claim 8, wherein the left generally horizontal support arm includes a left outer sleeve and a left rear telescoping member slidably disposed within the left outer sleeve and releasably attachable thereto, and the right generally horizontal support arm includes a right outer sleeve and a right rear telescoping member slidably disposed within the right outer sleeve and releasably attachable thereto.

14. The mower utility container accessory of claim 9, wherein a rearward end of the left generally horizontal support arm is attached to a left handle of a push lawnmower, a rearward end of the right generally horizontal support arm is attached to a right handle of the push lawnmower, the left generally vertical support leg is resting on top of a mower deck of the lawnmower, and the right generally vertical support leg is resting on top of the mower deck.

15. A method of improving a push lawnmower having a left handle, a right handle, and a mower deck, the left and right handles extending upwardly away from the mower deck at an inclined angle, the method comprising:
providing a mower utility container accessory comprising a container bucket, and a support frame having a left generally horizontal support arm, a right generally horizontal support arm, a left front generally vertical support leg, a right front generally vertical support leg, and a front generally horizontal cross member, the left generally horizontal support arm and the right generally horizontal support arm being spaced apart in generally parallel relationship and connected together by the front generally horizontal cross member, the front generally horizontal cross member being disposed in generally perpendicular relationship to the left generally horizontal support arm and the right generally horizontal support arm, the left generally vertical support leg being connected adjacent a forward end of the left generally horizontal support arm in generally perpendicular relationship thereto, the right generally vertical support leg being connected adjacent a forward end of the right generally horizontal support arm in generally perpendicular relationship thereto, and a forward end of the container bucket being rotatably connected to the front generally horizontal cross member, the container bucket being rotatably moveable between a lower position and an upper position;
attaching a rearward end of the left generally horizontal support arm to the left handle of the lawnmower;
attaching a rearward end of the right generally horizontal support arm to the right handle of the lawnmower;
positioning the left generally vertical support leg on the mower deck; and
positioning the right generally vertical support leg on the mower deck.

16. The method of claim 15, wherein the mower utility container accessory further includes a rear generally horizontal cross member connected between and disposed in generally perpendicular relationship to the left generally horizontal support arm and the right generally horizontal support arm.

17. The method of claim 15, wherein the left generally vertical support leg is connected to the front generally horizontal cross member in generally perpendicular relationship thereto, and the right generally vertical support leg is connected to the front generally horizontal cross member in generally perpendicular relationship thereto.

18. The method of claim 15, wherein the left generally vertical support leg includes a left outer sleeve and a left telescoping member slidably disposed within the left outer sleeve and releasably attachable thereto, and the right generally vertical support leg includes a right outer sleeve and a right telescoping member slidably disposed within the right outer sleeve and releasably attachable thereto.

19. The method of claim 15, wherein the left generally vertical support leg is rotatably connected to a forward end of the left generally horizontal support arm and releasably attachable thereto, and the right generally vertical support leg is rotatably connected to a forward end of the right generally horizontal support arm and releasably attachable thereto.

20. The method of claim 15, wherein the left generally horizontal support arm includes a left outer sleeve and a left rear telescoping member slidably disposed within the left outer sleeve and releasably attachable thereto, and the right generally horizontal support arm includes a right outer sleeve and a right rear telescoping member slidably disposed within the right outer sleeve and releasably attachable thereto.
